(19) United States
(12) Patent Application Publication
(10) Pub. No.: US 2014/0017139 A1
(43) Pub. Date: Jan. 16, 2014

(54) APPARATUS FOR DECOMPOSITION OF NITROUS OXIDE IN A GAS STREAM

(71) Applicant: István Szabó, Boda Kyrkby (SE)

(72) Inventor: István Szabó, Boda Kyrkby (SE)

(73) Assignee: Medclair AB, Boda Kyrkby (SE)

(21) Appl. No.: 14/007,302

(22) PCT Filed: Mar. 23, 2012
(86) PCT No.: PCT/SE2012/000044

§ 371 Date: Sep. 24, 2013

Related U.S. Application Data
(60) Provisional application No. 61/469,369, filed on Mar. 30, 2011.
(60) Provisional application No. 61/469,381, filed on Mar. 30, 2011.

(30) Foreign Application Priority Data
Mar. 24, 2011 (SE) 1130018-3
Mar. 30, 2011 (SE) 1130019-1
Apr. 7, 2011 (SE) 1130026-6

(51) Int. Cl. B01D 53/56

(52) U.S. Cl. CPC B01D 53/565
USPC 422/173

(57) ABSTRACT

An apparatus (100,200) for the removal of nitrous oxide in a gas stream (101,201) containing nitrous oxide which is derived from exhalation air and present in the gas stream in a concentration supporting exothermic decomposition of nitrous oxide. The apparatus has a main flow line (102,202) with: a) an inlet arrangement (103,203) with an inlet port (105,205), b) an outlet arrangement (104,204) with an outlet port (106,206), and between these arrangements c) a decomposition chamber (107,207). The main characteristic feature is that the decomposition chamber contains a catalyst material (108,208) promoting the decomposition of nitrous oxide to N2 and O2 together with a heat neutralizing medium (109,209).

### TECHNICAL FIELD

The present invention relates to an apparatus and a method for the removal of nitrous oxide (N₂O) in a gas stream containing nitrous oxide derived from exhalation air, e.g. derived from an individual inhaling a gas containing nitrous oxide. Previously known apparatus of this kind typically has a main flow line along which there are a) an inlet arrangement with an inlet port for the gas stream, b) an outlet arrangement with an outlet port for the gas stream processed within the apparatus, and between these two parts c) a through-flow chamber for removal of nitrous oxide (removal chamber) from the gas stream entering the apparatus through the inlet port.

### TECHNICAL BACKGROUND

Nitrous oxide is an air pollutant which is considered at least 300 times more effective than carbon dioxide as a “green house gas”. It is also considered hazardous for people exposed to it during work (e.g. doctors, dentists, nurses etc). Occupational health limits have been set to 25 ppm.

Nitrous oxide as such spontaneously decomposes when heated to temperatures of about 600° C. or higher into nitrogen and oxygen in a molar ratio of 2:1 with significant amounts of undesired by-products such as nitrogen oxides other than nitrous oxide, e.g. NOₓ (where x is 1 or 2). The reaction is strongly exothermic at concentrations of nitrous oxide higher than about 1-2% with a reaction rate which is increasing when the temperature is increased. This means that once the reaction is started, strict temperature control will be required if the reaction is to be used for the removal of nitrous oxide in waste gases containing elevated concentrations of nitrous oxide. Specific precautions are needed in order to control the amounts of NOₓ since discharge of NOₓ to the environment is strictly regulated. It is known that by using catalysts promoting decomposition of nitrous oxide an acceptable decomposition can be accomplished at lower concentrations of nitrous oxide (below 1-2%) at temperatures significantly below 600° C. without measureable evolution of heat.

Within health care units, nitrous oxide is used within surgery, dental care, maternity care during delivery etc due to its anaesthetic and analgesic effects on patients. The typical patient is allowed to inhale a gas mixture (=inhalation air) in which the main components are nitrous oxide, typically in concentrations ≧10%, such as ≧20% and/or ≦80%, such as ≦70% (v/v) and oxygen. When an enhanced anaesthetic effect is desired, the mixture typically also contains a gaseous anaesthetic agent (as a rule ≦10%, such as ≦5% or less ≦2% with typically levels being in the range of 0.25-3%, such as 0.5-2% (v/v)). Suitable anaesthetic agents have been selected amongst volatile halo-containing organic compounds, e.g. halo-containing hydrocarbons, halo-containing ethers etc, and other volatile organic compounds which are capable of exerting an anaesthetic effect, for instance anaesthetic hydrocarbons not containing halo substituents.

The composition of air exhaled by a patient receiving nitrous oxide and gaseous anaesthetic agents is essentially the same as the composition of the inhaled air except that there typically are increases in moisture (water) and carbon dioxide. Exhaled air from patients inhaling nitrous oxide is typically handled in a waste gas handling system which is common for several rooms/patients. In this kind of system the exhaled air is typically diluted with ambient air (e.g. 10-50 times). The exhaled is finally treated at the health care unit, e.g. in an apparatus for removal of nitrous oxide and/or passed into ambient atmosphere.

Typical principles for the removal of nitrous oxide have been a) catalytic decomposition, b) compression/condensation, and c) adsorption. Temperature control of catalytic decomposition after the exhaled air has passed through the common waste gas handling of a health care unit has been simple because the low concentration of nitrous oxide (below 1-2%) implies non-exothermic conditions. With proper selection of catalysts acceptable levels of undesired by-products, such as NOₓ, can easily be accomplished. Decomposition after removal according to alternatives (b) and (c) or decomposition without passing exhalation air through a central waste handling system is problematic. The nitrous oxide to be dealt with has a high concentration implying problems with its destruction at a health care unit.

During treatments involving administration of nitrous oxide the patient is now and then inhaling air containing nitrous oxide. Exhalation air will thus contain very high concentrations interrupted with irregular periods of zero concentration. This means that precautions are required when decomposing nitrous oxide in exhaled air from a single patient (close to the patient). During periods of high concentrations, the decomposition means increased risks for a) overheating and explosion due to an uncontrolled acceleration of the temperature, and b) formation of undesired levels of harmful by-products, such as NOₓ. The irregular switches between high and zero concentration further complicate the situation because they will mean uncontrolled switches in outcome of the reaction (products/by-products), reaction rate, concentrations, temperature etc.

There is a demand for apparatuses and methods for decomposing nitrous oxide derived from exhalation air containing nitrous oxide where the decomposition is carried out
a) at exothermic conditions, and/or
b) close to the patient, i.e. with the patient directly connected to the apparatus for removal of nitrous oxide.

An important demand on apparatuses/methods will be that the processed gas discharged from the apparatus must have an acceptable composition and temperature for being delivered to the room in which the patient and/or other people are present and/or the apparatus is placed. The apparatus/methods should therefore be able to provide sufficiently high reduction levels of nitrous oxide and formation of sufficiently low levels of nitrogen oxides, such as NOₓ. Other demands include that the flow velocity, amount, temperature etc of the discharged gas shall be acceptable for the ventilation of the room in which the patient and/or other people and/or the apparatus are present. Still other demands relate to effective control of the exothermic self-sustaining decomposition reaction that occurs at higher concentrations of nitrous oxide.

Catalytic removal of nitrous oxide from exhaled air from patients has been discussed: DE 42087521 (Carl Heyer GmbH), DE 4308940 (Carl Heyer GmbH), EP 2165756 (Linde AG), U.S. Pat. No. 4,259,303 (Kuraray Co., Ltd), WO 2011075033 (Nordic Gas cleaning AB), WO 20101071538 (Nordic Gas Cleaning AB), WO 2010081642 (Linde AG), WO 2010081643 (Linde AG), WO 2006059506 (U.S. Pat. No. 7,608,232; Showa Denko KK), WO 2002026355 (U.S. Pat. No. 7,235,222, U.S. Pat. No. 7,597,858; Showa Denko KK), JP publ No. 55-031463 (Kuraray Co Ltd), JP publ No. 56-011067 (Kuraray Co Ltd), JP publ No. 2006230795 (Asahi Kasei Chemicals Corp). EP 2165756 (Linde AG) expressly discusses close-to patient use and temperature regulation during exothermic decomposition of nitrous oxide.

Ek & Tjus have presented a study on a commercial unit for destruction of nitrous oxide at health care units (Decreased emission of nitrous oxide from deliver wards—case study in Sweden, Mitig. Adapt. Strateg. Glob. Change 13 (2008) 809-818, published online Mar. 14, 2008).

WO 2009095601, WO 2009095605 and WO 2009095611 (all of Air Liquid) deals with close-to patient apparatuses for adsorption of nitrous oxide from exhaled anaesthetic gas. Adsorption of nitrous oxide from exhaled air is also described in EP 0284227 (Union Carbide), EP 1356840 (Siemens-Elema), EP 1797942 (Univ Delft), international patent application PCT/SE2011/000202 (Nordic Gas Cleaning AB), U.S. Pat. No. 3941573 (Chapel), and U.S. Pat. No. 5,928,411 (Drägerwerk).

Compression and fractionation of exhaled air containing nitrous oxide and anaesthetic agents are discussed in WO 2006124578 (Anaesthetic Gas Reclamation LLC).

All patents and patent applications cited in this specification are hereby incorporated in their entirety by reference.

### OBJECTS OF THE INVENTION

The main objects comprise providing an apparatus and/or a method for carrying out catalytic decomposition of nitrous oxide used in health care to N₂ and O₂, i.e. which derives from exhalation air, where
a) the gas stream entering the apparatus contains nitrous oxide at a concentration providing exothermic conditions for catalytic decomposition of nitrous oxide, e.g. a concentration which is above 1-2%, such as ≧5%, or ≧10% or ≧20% (v/v), possibly interrupted by irregular periods of essentially zero concentration of nitrous oxide, and/or
b) the temperature for the decomposition is self-sustaining
   i) after the decomposition has been initiated by heating
      the incoming gas containing nitrous oxide at a concentration supporting exothermic conditions and/or
      the decomposition chamber (exothermic conditions), and
   ii) as long as nitrous oxide at a concentration supporting exothermic conditions is passing through the chamber, and/or
c) the apparatus and/or the method are adapted to be used close to the patient and suitable for connection to a single patient or to only a small number of patients treated in the same room, typically 1, 2 or 3 patients.

Further objects are to provide an apparatus and/or a method which are capable of providing one or more of:
1. decomposing of nitrous oxide to N₂ and O₂ exclusively with acceptable levels (trace levels) of nitrous oxide and nitrogen oxides other than nitrous oxide, such as NOₓ, in the effluent gas discharged through the outlet port of the apparatus. Preferably acceptable levels should appear already at the outlet of the decomposition chamber.
2. An acceptable temperature of the effluent gas discharged at the outlet port of the apparatus.
3. An acceptable proportion and/or flow velocity of treated gas in the gas stream discharged through the outlet port of the apparatus in relation to the ventilation system of the room in which the patient and/or the apparatus are placed.
4. A compact and movable apparatus facilitating easy transfer between different spaces and/or patients of a health care unit.

Subobjects are various combinations of the objects given above.

### DRAWINGS

FIG. 1a och b: FIG. 1a illustrates a version of the invention in which hot gas processed in a decomposition chamber that has a circular cross-sectional area is cooled by being mixed with a cooling gas after which the mixture is discharged through the outlet port. FIG. 1b is the same as FIG. 1a but the reference numerals have been replaced with dimensions (mm). DN stands for the diameter of conduits/tubes.

FIG. 2: This figure illustrates a version of the invention in which hot gas leaving the decomposition chamber is cooled by heat transfer to a fixed heat absorbent placed downstream of the decomposition chamber prior to being mixed with a cooling gas.

FIG. 3: This figure illustrates a preferred variant at the filing date of this specification in which warm gas leaving the decomposition chamber is used to pre-warm cold incoming gas in a conventional heat exchanger before being discharged to ambient atmosphere.

FIG. 4: This figure describes an adsorption unit that can be loaded with nitrous oxide during health care treatments. After loading the adsorbed nitrous oxide can be desorbed and passed into an apparatus according to FIG. 4 for decomposition of nitrous oxide.

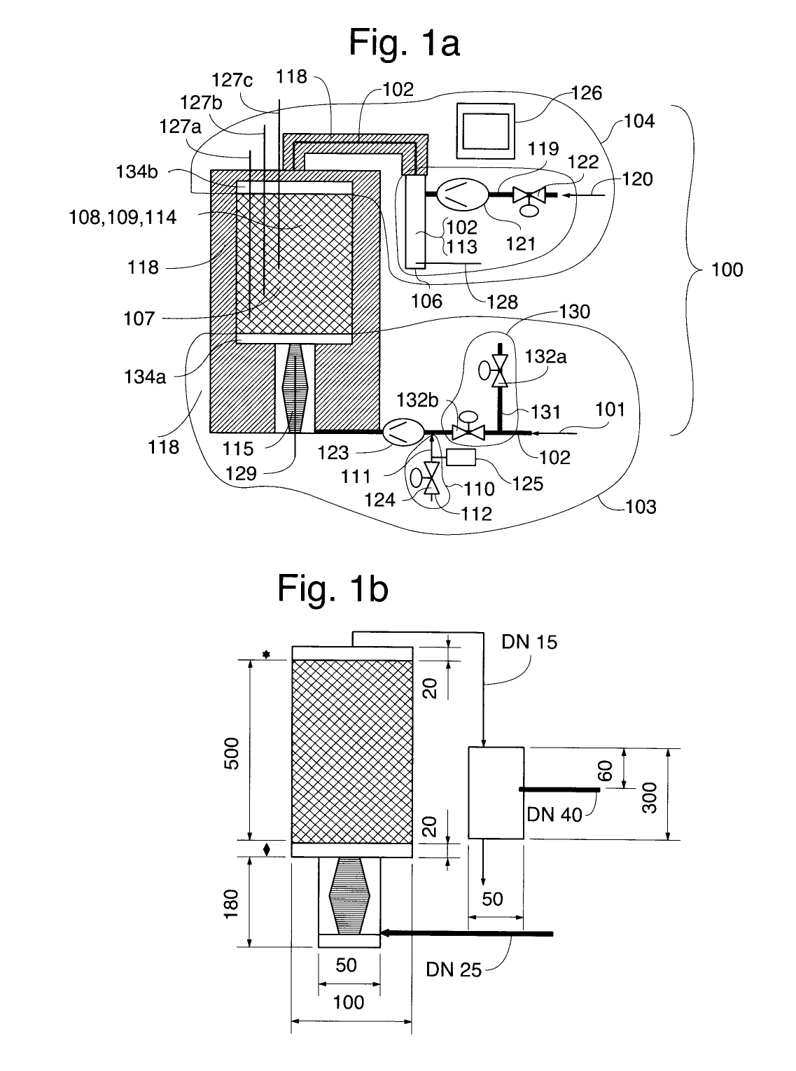

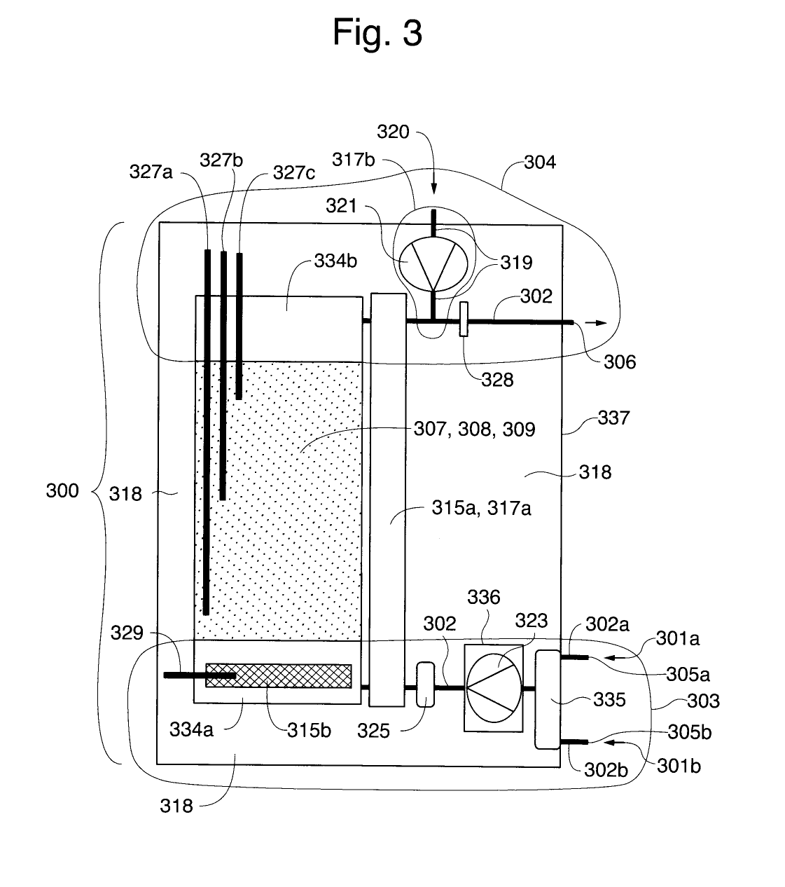

Reference numerals in the figures comprise three digits. The first digit refers to the number of the figure and the second and third digits to the specific item. Corresponding items in FIGS. 1-3 have as a rule the same second and third digits. FIG. 1 represents the best mode at the priority filing date and FIG. 3 the best mode at the international filing date.

### INVENTION

The present inventor has discovered that improved and convenient methods and apparatuses which at least partly comply with the objects discussed above can be accomplished if the apparatuses have a decomposition chamber which contains a catalyst material promoting the desired decomposition and arrange so that this catalyst material is in intimate heat transfer contact with a heat neutralizing medium in the chamber.

The present invention is thus an apparatus (100,200) for the removal of nitrous oxide in a gas stream (101,201) which contains nitrous oxide at a concentration supporting exothermic decomposition of nitrous oxide. This typically means that the concentration of nitrous oxide entering the apparatus is above 1-2%, such as ≧5% or ≧10% or ≧20% or ≧50% (v/v). Nitrous oxide to be decomposed in the apparatus and by the method of the invention is derived from air exhaled by an individual inhaling a gas containing nitrous oxide. Thus the gas to be processed in the apparatus may be concentrates of nitrous oxide derived from exhalation air, or exhalation air as such or dilutions thereof as long as the concentration of nitrous oxide is above 1-2%. This apparatus is in particular useful for decomposing nitrous oxide collected by the use of the adsorption units of the system described in our international patent application filed in parallel with this application “system” claiming priority from U.S. Ser. No. 61/469,369, SE 1130019-1 and SE 1130026-6).

The apparatus comprises a main flow line (102,202) which has: a) an inlet arrangement (103,203) with an inlet port (105,205) for the gas stream (101,201) containing exhaled air, b) an outlet arrangement (104,204) with an outlet port (106,206) for discharging the gas stream processed within the apparatus and c) between these arrangements a through-flow removal chamber (107′,207′) which is a flow-through decomposition chamber (107,207) in which nitrous oxide is decomposed. This chamber will further on be called decomposition chamber (107,207).

Two main characteristic feature of apparatus of the invention comprises that
a) the decomposition chamber (107,207) contains a catalyst material (108,208), which promotes the decomposition of nitrous oxide to N₂ and O₂, and a heat neutralizing medium (109,209) in intimate heat transfer contact with each other within the chamber (207), and/or
b) there is a gas diluting function (110,210) in the inlet arrangement (103,203).

Feature a) means that the heat neutralizing medium (109,209) and the catalyst material (108,208) (107,207) will support efficient decomposition of nitrous oxide to N₂ and O₂ under controlled exothermic conditions. The term “intimate” in this context in particular includes that the contact supports maintenance of the temperature in the decomposition chamber at an acceptable level, which in turn depends on the stability of the catalyst material, the heat neutralizing media, the material from which the chamber is manufactured etc and also variables such as effective working temperature range for the catalyst material. As a rule an acceptable working temperature is as low as possible and normally <1000° C., with preference for <900° C. or <800° C. or <750° C.

The main characteristic feature can be combined with a gas diluting function (110,210) which comprises an inlet flow line (111,211) for a diluting gas (112,212) merging with the main flow line (102,202) at a position upstream of the decomposition chamber (107,207).

The diluting function (110,210), when present, is used to control heat evolution during the exothermic decomposition reaction taking place within the decomposition chamber (107,207). This may be important when higher concentrations of nitrous oxide are present in the gas stream which is about to enter the apparatus, i.e. for concentrations at which the capacity of the heat neutralizing medium is insufficient for maintaining the temperature of the catalyst and/or the decomposition chamber within an acceptable temperature interval. The inlet flow line (111,211) of the diluting function typically comprises an inlet valve (124,224) for opening and closing the inlet flow line (111,211), e.g. enabling gradual opening or being a stop-flow valve. In order to accomplish efficient control of the temperature within the decomposition chamber (107,207), the diluting function (110,210) preferably is associated with a) a sensor arrangement (125,225) for measuring a flow parameter (e.g. flow velocity) and/or temperature in the decomposition chamber/catalyst material, and/or b) a flow creating function (123,223a), such as a blower, which can be used for changing the flow velocity in the main flow line (102,202) and in the inlet flow line (111,211). The diluting function (110,210) should be capable of varying the dilution of incoming gas containing nitrous oxide around a preset value which typically is within the interval of 1:1 to 1:50. The preferred concentrations of nitrous oxide which enters the decomposition chamber are thus within the lower part of the exothermic concentration range, e.g. concentrations within the interval of from about 1-2% to about 40% or about 50%, with higher preference for about 1-2% up to about 25% or 1-2% up to about 15% or up to about 10% (v/v). During operation the valve (124,224), if present, may be set to a predetermined value, e.g. fully or partly opened, and/or the flow creating function (123,223a,b) to a predetermined flow velocity. One or both of these two parameters may then be changed in response to values measured by sensors placed along the main flow lines, such as one or more of the temperature sensors (127a,b,c,227a,b,c) associated with the decomposition chamber (107,207) and flow sensors (125,225).

### Decomposition Chamber

The decomposition chamber (107,207) may be present in a common housing (=decomposition unit) which also may contain a) the inlet arrangement (103,203), and/or b) the outlet arrangement (104,204), and/or c) one or more parts of these arrangements. The parts which are present in the housing may be selected amongst functions described under the various subheadings below, for instance an upstream heating arrangement (115,215), an upstream cooling arrangement (216) (heat insulation), one or more of the downstream cooling arrangements (117,217a,b,c etc), diluting functions (110,210) valve functions (122,124,222,224) etc.

The chamber (107,207) and other hot parts of the inventive apparatus are preferably heat insulated (118,218) in order to facilitate efficient temperature control, protect people working close to the apparatus from burn injuries, avoid undesired warming up of the surroundings etc.

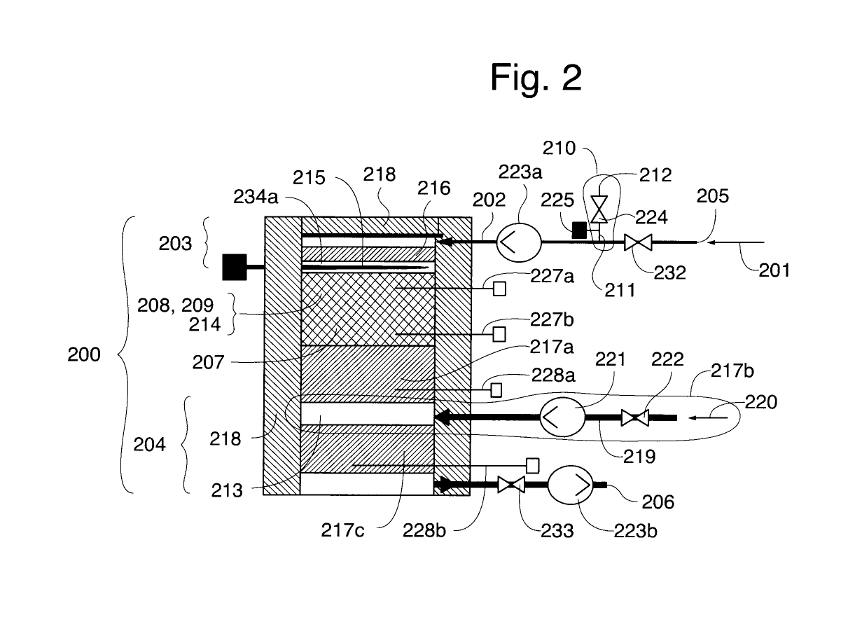

The decomposition chamber (107,207) in the invention is the volume of the main flow line defined between the most upstream part and the most downstream part of the main flow line which contain catalyst material (108). In certain variants, which are illustrated in FIG. 2, there may be a heat absorber (217a) placed immediately downstream of the chamber (207) in physical contact with its downstream end. The interface between the chamber (207) and the heat absorber (217a) is then part of the chamber.

The heat neutralizing medium (109,209) in the decomposition chamber (107,207) is typically a heat absorber. There are mainly two different kinds of heat absorbers that can be used:
a) fixed heat absorbents (109,209) (also called heat buffers) which are capable of retaining absorbed heat, e.g. in the form of a porous monolith or more preferably porous or non-porous particles which typically are used in the form of a packed bed, and
b) heat absorbers in the form of conduits through which a cooling fluid is passing for removing heat taken up by the fluid via the walls of the conduits (fluid=gas or liquid) (not shown).

Preferred catalyst materials are in the form of porous and/or non-porous particles which can be packed to a porous bed (114,214). Porous monolithic forms are of potential interest, e.g. nets (not shown), porous plugs (not shown) etc.

In the decomposition chamber (107,207) intimate heat transfer contact between the catalyst material (108,208) and the heat neutralizing medium (109,209) can be strengthened by arranging so that the catalyst material and the heat neutralizing medium are mutually embracing each other. In other words the heat neutralizing medium should extend into and/or surround the catalyst material to minimize local areas of heat excess that would cause the decomposition reaction to run out of control within such areas and subsequently also throughout the chamber. Heat neutralizing media which are present in the decomposition chamber should thus surround the catalyst material, and may for instance be more abundant in one or more zones or segments compared to bordering and/or more or less evenly distributed in the volume occupied by the catalyst material.

The catalyst material and the heat neutralizing medium are in preferred variants essentially homogenously distributed in relation to each other within one or more zones of the chamber (107,207). If both the heat absorbing material and the catalyst material are in the form of particles, the two materials are preferably mixed with each other to form a porous bed (=a catalyst/heat absorbing zone).

Within the chamber (107,207) there may be none, one, two or more zones that are empty with respect to containing heat neutralizing medium and/or the catalyst material.

The term “zone” in this context includes that there are variants in which there is only one zone containing catalyst material. The zone then coincides with the volume of the chamber.

The catalyst material may comprise a support material to which the catalyst is attached (carrier or support for the catalyst). The support material for a catalyst and the heat absorbing material may be of the same or different kind of material. In one variant the support material for the catalyst may also be functioning as heat absorbing material meaning that there are variants of porous beds for which there is no need for a separate heat absorbing material not carrying the catalyst.

Typical physical and geometric appearances of catalyst material and heat neutralizing media are outlined in WO 2010071538 and WO 2011075033 (both Nordic Gas Cleaning AB).

The catalyst material is selected as outlined in WO 2010071538 and WO 2011075033. Suitable catalyst materials may thus be found amongst those that are effective for decomposing nitrous oxide to N₂ and O₂ at a temperature that typically should be within the interval of 200-900° C., such as within 350-900° C. or 350-750° C. or 350-550° C. or 400-500° C.

Suitable catalyst materials shall give only trace levels of nitrous oxide in gas exiting the decomposition chamber (107,207) and/or the outlet port (106,206). Trace levels in this context means levels of nitrous oxide ≦4000 ppm, such as ≦1000 ppm or ≦500 ppm. Trace levels of nitrous oxide may alternatively and preferably mean that the level of nitrous oxide in gas leaving the decomposition chamber relative to its level in gas entering the chamber is ≦50%, preferably ≦40% or ≦30% or ≦20%, such as ≦10% or ≦5% or ≦1% (which corresponds to a reduction ≧50%, preferably ≧60% or ≧70% or ≧80%, such ≧90% or ≧95%≧99%). The levels of nitrous oxide exiting through outlet port (106,206) may be further reduced in variants of the invention which utilizes a downstream cooling arrangement of alternative (i) (FIGS. 1 and 2, (117,217b)), i.e. cooling by dilution with air. Levels at the outlet port (106,206) may then be reduced to ≦250 ppm, such as ≦100 ppm≦50 ppm or ≦25 ppm and a relative reduction of ≧99.5% such as ≧99.9%.

Suitable catalyst materials shall also give trace levels of nitrogen oxides (NOₓ) other than nitrous oxide in gas leaving the decomposition chamber (107,207). This primarily refers to ≦2 ppm, such as ≦1 ppm or ≦0.5 ppm or ≦0.1 ppm or ≦0.05 ppm. The same limits also apply for gas exiting the apparatus via its outlet port (106,206) and may be further reduced with a factor in the interval 0.05-0.5 if a cooling arrangement of alternative (i) (cooling by dilution with air) is included in the apparatus as discussed in the preceding paragraph.

The preferred catalyst material is as outlined in WO 2010071538 (Nordic Gas Cleaning AB) and typically comprises a catalytically active metal oxide containing either one or both of copper oxide and manganese oxide, and/or a support material which preferably is in the form of particles and/or typically is based on alumina. The amount of the catalytically active metal oxide is typically in the range of 5-30% with preference for 11-17% (by weight).

It has surprisingly been found that suitable catalyst materials can be found amongst catalyst materials which are capable of decomposing volatile organic compounds under oxidative conditions. This in particular applies to catalyst material comprising the composition discussed in the previous paragraph.

What has been said about selection of catalyst material above does not exclude that there may be benefits with catalyst material more or less specifically dedicated for the decomposition of nitrous oxide. This includes catalyst material containing other metals than those specifically preferred by us earlier possibly in combination with our earlier preferences (WO 2010071538). Such other metals may be selected from palladium and/or rhodium and many others. This also includes catalyst material having optimal working efficiency at the lower part of the temperature interval given above. See WO 2010071538 and WO 2011075033 and references cited therein.

Heat absorbing materials are commercially available in various geometrical forms and with different heat capacities and thermal conductivities. The heat absorbing material that we have found will work well is in particulate form and has according to the manufacturer a heat capacity of 1.1 kJ/kg and K and a thermal conductivity of 14.6 kJ/m, h and K. See also the experimental part in this specification and in WO 2010071538 and WO 2011075033 (regenerative heat exchanger). People in the field will have no difficulties in finding other acceptable heat absorption materials by selecting from those that are in the form of particles and have heat capacities ≧0.1 kJ/kg and K with preference for those of higher heat capacities, such as ≧0.4 kJ/kg and K, or ≧0.8 kJ/kg. An upper limit is typically ≦10 kJ/kg. Optimisation of heat absorbing material with respect to thermal conductivity is believed to be less critical and has therefore not been investigated in detail.

Within or in the vicinity of the decomposition chamber (108,208) there may be one or more temperature sensors as discussed under the heading Control Unit.

Immediately upstream of the decomposition chamber (108,208) there is preferably a distribution function (134a,234a) for even distribution of incoming gas across the cross-sectional area of the decomposition chamber/catalyst material/heat neutralizing medium. The outlet end of the decomposition chamber may similarly be associated with a collector function (134b) for flow exiting the chamber. Either one or both of these two functions preferably comprise a zone of empty space (gap) (134a,134b,234a). This kind of zone is devoid of heat-neutralizing medium and catalyst material and covers the appropriate end of the chamber (107,207). These two functions, if present, are part of the inlet arrangement (103,203) and the outlet arrangement (104,204), respectively.

### Heating and Cooling Arrangements

The main flow line (102,202) typically comprises a heating arrangement (115,215) for preheating the gas stream which is about to enter the decomposition chamber (107,207) (upstream heating arrangement). This arrangement (115,215) comprises one or more heating elements (115b,215b) placed upstream of and/or within the upstream part of the decomposition chamber, with preference within the upstream gap (234a) discussed above.

The effect of the heating elements (115b) is preferably gradually adjustable, e.g. stepwise or continuously, within a certain range with a maximal effect being ≧0.5 kW, such as ≧1 kW or ≧1.5 kW with a typical upper limit of 2 Kw or 5 kW.

The main flow line (202) may comprise an upstream cooling arrangement (216) (heat insulation) which is capable of preventing transport of heat to the most upstream parts of the apparatus (200). This arrangement preferably comprises a heat absorber of the same kind as discussed below for the downstream cooling arrangements (ii) and (iii) (117,217a,c), i.e. a fixed heat absorbent and/or a heat absorber containing a through-flowing cooling fluid (see below). The arrangement (216), if present, is placed upstream of the decomposition chamber (207), and preferably also upstream of the heater (215b), if present.

In preferred variants the apparatus comprises one, two or more cooling arrangements (117,217) for cooling the gas stream after it has exited the decomposition chamber (107,207), i.e. downstream cooling arrangements. Useful downstream cooling arrangements/principles are:
i) an inlet flow line (119,219 as part of 117,217b) for inlet of a stream of a cooling gas (120,220) into the main gas flow line (102,202) to be mixed with the gas stream in the main flow line at a position downstream of the decomposition chamber (107,207).
ii) a heat absorber (217a,c) (=heat buffer) in the form of a fixed heat absorbent which is placed in heat transfer contact with gas passing through the downstream part of the main flow line (202), and
iii) a heat absorber (317a, FIG. 3), which comprises conduits for a stream of cooling fluid (gas or liquid) in heat transfer contact with gas passing through the downstream part of the main flow line.

The mixing in alternative (i) is typically taking place in a mixing function (113,213) which in FIG. 1 is represented by a tube having a larger diameter than the main flow line upstream of the mixing function and being open at its downstream end.

When there are two or more downstream cooling arrangements, at least two of them utilize the same or different cooling principles.

In alternative (i) the inlet flow line (119,219) for cooling gas typically comprises a flow creating function (121) for
a) inducing flow and/or changing the flow velocity of in-coming cooling gas (increasing and/or decreasing) and/or
b) changing the temperature (decreasing and/or increasing) of gas discharged through the outlet port (106,206) of the main flow line (102,202).

The flow creating function (121) preferably comprises a blower, and/or is adjustable with respect to gradually changing the flow velocity of the cooling gas passing through the inlet flow line (119,219). An increase in the flow velocity in inlet flow line (119,219) will mean a decrease in the temperature of gas discharged through the outlet port (106,206). The cooling gas is preferably ambient air or a gas, e.g. air, from some other source, such as a gas tube. The inlet flow line (119,219) typically also comprises a valve function (122,222) for opening and closing this inlet flow line, for instance gradual opening and closing.

The head absorbing material in alternative (ii) is selected amongst the same materials as the heat absorbing material in the chamber is selected.

The cooling fluid in alternative (iii) (FIG. 3) is preferably a cooling gas, e.g. air from ambient atmosphere, or a cooling liquid. The preferred downstream cooling arrangement of alternative (iii) has during the priority year turned out to be the cooling function of a conventional heat exchanger (315a) in which warm gas leaving the decomposition chamber (307) is used to preheat incoming cold gas rich in nitrous oxide. See FIG. 3. This kind of heat exchanger (315a) will be part of the heating arrangement (315a+b).

In combinations of downstream cooling arrangements, one of them is preferably according to alternative (i) (117,217b). This cooling arrangement may be placed upstream or downstream of one or more of the other downstream cooling arrangements (if such other arrangements are present).

In other combinations, one of the downstream cooling arrangements is according to alternative (ii) (217a,c) and is placed upstream or downstream of one or more of the other downstream cooling arrangements (if such other arrangements are present). Alternative (ii) is then preferably placed next to the decomposition chamber (207a), i.e. downstream of the chamber with its interfacing surface being part of the chamber.

In still other combinations, one of the downstream cooling arrangements is according to alternative (iii) (FIG. 3). This cooling arrangement may be placed upstream or downstream of one or more of the other downstream cooling arrangements (if such other arrangements are present), with preference for upstream of a cooling arrangement (i) if such an arrangement is present.

The downstream part of the main flow line preferably comprises one or two different cooling arrangements selected amongst (i)-(iii) above. Four variants are (1) cooling arrangement (i) (217b) with no cooling arrangements (ii) and (iii), (2) cooling arrangements (i) (217b) plus (ii) (217a,c) with no cooling arrangement (iii), and (3) cooling arrangement (ii) with no cooling arrangement (i) or (iii) (not shown), and (4) cooling arrangements (i) plus (ii) with no cooling arrangement (ii) (FIG. 3). For variant (2), a cooling arrangement (i) may be placed upstream or downstream of a cooling arrangement (ii) with preference for downstream. A grading of preferences for the alternatives is: (4)>(1)>(2)>(3) when designed as discussed above.

At least one of the downstream cooling arrangements of an apparatus of the invention is preferably adjustable in the sense that the cooling effect can be adjusted in response to variations in the temperature of the gas flow to be cooled. Examples of adjustable cooling arrangements are alternatives (i) (117,217b) and (iii) with preference for (i) (117,217b).

The positions of the downstream cooling arrangements refer to which part of the main flow line the arrangements are acting on.

### Inlet Arrangement

The inlet arrangement (103,203) of the main flow line (102,202) contains the part of main flow line which passes through this arrangement. In addition the inlet arrangement may contain at least one of
(a) an inlet flow line (111,211) for a diluting gas (112,212),
(b) a flow creating function (123,223a,b),
(c) a valve function (124,224) for regulating the influx flow velocity of the diluting gas (112,212), and
(d) a sensor arrangement (125,225) for measuring one or more flow parameters, such as a pressure sensor (subpressure) and/or a flow meter.

Details of (a)-(d) are discussed elsewhere in this specification.

The inlet arrangement (103,203) also comprises the distributor function (134a,234a) (if present) which is discussed under Decomposition chamber.

The inlet arrangement may also have a by-pass function (130) which comprises an outlet flow line (131) branching from the main flow line (102) at a position upstream of the decomposition chamber (108). The preferred position is upstream of the merging between the main flow line (102) and the inlet flow line (111) of the diluting function (110), if present. This by-pass function comprises a 2-way valve function (132a+b) enabling in a stop-flow manner opening/closing of the main flow line (102) with simultaneous closing/opening of the by-pass outlet flow line (131). The valve function (132a+b) may comprise a stop-flow valve (132a) in the by-pass outlet flow line (131) combined with a stop-flow valve (132b) in the main flow line. The downstream part of the by-pass outlet flow line (131) typically may be in flow communication with ambient atmosphere, e.g. by first merging with the main flow line (102) at a position downstream of the decomposition chamber (107) or via the ventilation system of the room in which the apparatus is placed. This kind of by-pass-function is also preferred for the apparatus of FIG. 2 (not shown).

The inlet arrangement (103,203) may also contain a particle filter and/or one or more through-flow absorbents for water and organic anaesthetic agents, respectively, as generally discussed in WO2010071538 (Nordic Gas Cleaning AB) and references cited therein

### Outlet Arrangement

The outlet arrangement (104,204) typically has one or more downstream cooling arrangements, flow creating functions, valve functions, sensor functions, collector function etc as discussed elsewhere in this specification.

### Flow Regulating System

This system comprises one or more flow creating functions (121,123,221,223a,b) placed along the main flow line (102,202) and/or in flow lines merging with (111,119,211,219) or branching from the main flow line (102,202) and/or valve functions (122,124,222,224,232,233) and/or sensor arrangements (125,225) for measuring flow parameters along these flow lines.

The main flow line (102,202) typically comprises a main flow creating function (123, 223a,b) for regulating the gross flow within the main flow line including in particular through the decomposition chamber (107,207). This function is preferably adjustable, such as gradually adjustable, with respect to capability to vary the flow velocity through the main flow line (102,202). The function may comprise one or more parts (123,223a,b), e.g. one or more blowers, with at least one of them preferably being adjustable with respect to flow velocity. This flow creating function (123,223a) preferably is placed upstream of the decomposition chamber (107,207), such as within the inlet arrangement (103,203). If containing a part (223b) that is placed downstream of the decomposition chamber (207) there should preferably be a downstream cooling arrangement (217a,b) placed between it and the decomposition chamber (207).

A flow creating function (121,221) in a flow line which merges with the main flow line (102,202) may be adjustable in the same manner as flow creating function (123,223a,b) in the main flow line.

Valve functions may be associated with the merging of inlet flow lines with and the branching of flow lines from the main flow line (102,202). Thus there may be
a) a valve function (122,222) associated with the inlet flow line (119,219) for cooling gas in a cooling arrangement of alternative (i) (117,217b), and/or
b) a valve function (124, 224) associated with the inlet flow line (111,211) for diluting gas, and/or
c) a valve function (132) associated with a by-pass function (130) and/or
d) a valve function (232,233) associated with an inlet port (205) or an outlet port (206), respectively.

These valve functions are capable of closing/opening the flow lines as previously discussed.

The flow regulating system should have the capacity to give
i) an inlet flow of 0.1-1 m³/h through the inlet port (105,205) of the apparatus (incoming gas containing nitrous oxide),
ii) an inlet flow of 0.1-30 m³/h, such as 0.3-9 m³/h, through the inlet flow line (111,211) for a diluting gas upstream of the decomposition chamber (107,207) (if a diluting gas is used),
iii) an inlet flow of 1-500 m³/h, such as 10-100 m³/h through the inlet flow line (119,219) for a cooling gas in a downstream cooling arrangement (i) (117a,217b) (if this kind of cooling arrangement is present).

The diluting inlet flow velocity according to (ii) depends on factors such as the inlet flow velocity according to (i) above, concentration of nitrous oxide in incoming gas, the heat absorbing capacity of the heat absorber in the decomposition chamber, the actual temperature in the decomposition chamber during ongoing decomposition etc and should support exothermic conditions at an acceptable temperature within the decomposition chamber once the process temperature is achieved. Suitable dilution factors supported by the diluting inlet flow (alternative (ii)) on the main flow alternative (i)) are typically found within the interval of 1:1 to 1:50 (v/v).

The applied inlet flow velocity of the cooling gas (alternative (ii) depends on the temperature and the flow velocity of the main flow at the merger of the inlet flow line (119,219) for a cooling gas with the main flow line (102,202). The cooling gas should support that the temperature of gas discharged through the outlet port (106,206) of the apparatus is <55° C., such as <45° C. See also Temperature Regulating System below.

### Temperature Regulating System

The temperature regulating system comprises the heating arrangement (115,215) and the cooling arrangements (117,216,217) discussed above. The heating arrangement is used to preheat gas which is about to be treated in the decomposition chamber (107,207). When the process temperature is reached the effect of the heating arrangement can be lowered and sometimes switched off due to the exothermic conditions. The decomposition reaction becomes self-sustaining as long the appropriate concentration of nitrous oxide is available.

The heater should be capable of continuous heating of the gas stream/decomposition chamber during use of the apparatus and allow for gradual changes in the heating.

The decomposition reaction is exothermic and its rate will accelerate when the temperature is increasing. The acceleration and/or the reaction rate as such will slow down when the concentration of nitrous oxide and/or the flow velocity of gas containing nitrous oxide is lowered. Accordingly, an inlet function (110,210) for a diluting gas as described above and/or the flow creating function (123,223) may be used as part of the temperature regulating system for the decomposition chamber.

Similarly an inlet flow line (119,219) for a cooling gas in cooling arrangement of alternative (i) (117,217b) and the possible valve function (122,222) and/or flow creating function (121) associated with this flow line are also part of the temperature regulating arrangement of the inventive apparatus. See above.

### Control Unit

The control unit of the apparatus comprises
a) various sensors placed at critical positions along the main flow line for measuring critical process parameters, and
b) preferably also a control block (126) comprising software and hardware for i) collecting and evaluating values for the different process parameters measured by the sensors during the process, ii) controlling/checking and adjusting the settings of the different functions of the flow and/or temperature regulating systems to be within preset intervals (e.g. settings of blowers and heaters, respectively), iii) activating alarm functions etc, and.
c) preferably one or more alarm functions alerting when something needs to be inspected.

The most critical process parameters are: i) the temperature within the decomposition chamber (107,207) and in the gas to be discharged through the outlet port (106,206) of the apparatus, and ii) flow-related parameters, such as flow velocity and/or pressure, in the main flow line, preferably at the position of inlet functions (110,210,117,217b) for diluting gas and cooling gas, respectively.

The control block (126) contains parts that may be placed within or on the apparatus as such or as separate physical entities. The communication between various sensors, flow regulating functions and temperature regulating functions takes place via the control unit by wire-less contact or via wires. The control block typically also comprises a display on which the on-going process can be monitored.

### Temperature Sensors

The apparatus of the invention preferably has
a) one, two, three or more temperature sensors (127a,b,c . . . ,227a,b,c . . . ) placed in the decomposition chamber (107,207) at different positions along the flow direction,
b) at least one temperature sensor (128,228a,b) associated with the outlet arrangement (104,204) of the main flow line (102,202), and/or
c) a temperature sensor (129) associated with the heating arrangement (115).

Within the decomposition chamber (107,207) typical positions for a temperature sensor are within the upstream part (127a,227a), within the downstream part (127c,227c) and within the middle part (127b) of the chamber as illustrated in the drawings. The temperature sensor close to the inlet end (127a,2) of the chamber is preferably the controlling temperature sensor for the heating arrangement (115,215). When the temperature measured by a controlling temperature sensor is deviating from a preset temperature value/interval this may be counteracted via the control block (116) by increasing/decreasing
a) the effect of the heating arrangement (115,215) and/or
b) the flow velocity by the use of the flow creating function (123,123a,b) and/or
c) the concentration of nitrous oxide by increasing/decreasing the influx of diluting gas through inlet valve (124,224) relative to the flow in the main flow line.

The temperature sensor (128) is typically a safety thermostat and/or is typically placed after or within one or more of the downstream cooling arrangements (117,217), with preference for the most downstream one (117,217c). When the temperature at this sensor is above a preset value the cooling effect of a downstream cooling arrangement is increased. For the variants of FIGS. 1 and 2 this means by increasing the influx of cooling fluid (gas) in cooling arrangement (117,217b) by aid of the flow creating function (121) via the control block.

The temperature sensor (129) is preferably designed as a safety thermostat and/or is linked to closing down of the apparatus when there is a high risk for overheating. Closing down typically includes by-passing incoming gas containing nitrous oxide via flow line (131) (valve (132b) closed and valve (132a) open) and inlet of air (112) via inlet flow line (111) (valve (124) open).

### Flow Sensors

Typical flow sensors (125,225) are flow meters and/or pressure sensors. If present they are preferably placed at the merging of an inlet flow line with the main flow line, i.e. in inlet flow lines (111,211) and/or (119,219) or in the main flow line (in particular if the merging inlet flow line is not present and then preferably downstream a possible flow creating function).

Values of process parameters measured by the sensors can be used by the control block to adjust corresponding process parameters to be optimal for discharging processed gas of sufficiently low temperature and containing acceptable levels of nitrous oxide and NOₓ. Typical process parameters involved are
a) the temperature in the decomposition chamber (107,207) and at the outlet (106,206) of the main flow line,
b) flow velocity and/or pressure/subpressure, for instance upstream or downstream of a flow creating function (123,223a,b) and/or if a diluting function (110,210) is present at the merging of an inlet flow line (111,211) with the main flow line (102,202),
c) concentration of nitrous oxide in gas entering the decomposition chamber (107,207),
d) flow velocity of a cooling gas possible entering the main flow line via cooling arrangement (i) (117,217b), and/or
e) the flow velocity of incoming diluting gas.

There may also be sensor and sensor arrangements, e.g. sensor arrangements for measuring nitrous oxide and NOₓ, respectively, in the gas to be discharged through the outlet port. For nitrous oxide this means either or both of absolute concentrations and/or relative concentrations as discussed above (including also determining reduction levels for nitrous oxide).

The sensors discussed above may be linked to various alarm functions alerting when the process is not in working properly and/or to closing down functions.

### Method Aspect

This main aspect of the invention comprises the use of the apparatus for decomposition under exothermic conditions of nitrous oxide derived from exhalation air containing nitrous oxide. The use corresponds to a method which comprises the steps of:
i) providing an apparatus as defined above and/or in the appending claims,
ii) connecting a source containing nitrous oxide derived from exhalation air to the inlet port of the apparatus,
iii) flowing nitrous oxide from the source connected in step (ii) to the apparatus through the decomposition chamber of the apparatus while maintaining controlled exothermic decomposition conditions in the chamber as discussed in this specification.

The source to be connected to the apparatus may be an individual exhaling nitrous oxide. The source may alternatively be a storage form containing dilutions and/or concentrates of nitrous oxide obtained from exhaled air which contains nitrous oxide. This includes that the concentration of nitrous oxide in gas entering through the inlet port of the apparatus is >1-2% (v/v) and that the nitrous oxide has initially been collected from exhaled air and/or subsequently condensed and/or concentrated and/or absorbed/desorbed and possibly also pooled and/or stored.

### Developments During the Priority Year.

FIG. 3 illustrates the best mode apparatus (300) of the invention at the end of the priority year. The apparatus comprises a main flow line (302) for process flow. Along the flow line there are an inlet arrangement (303), an outlet arrangement (304) and between these arrangements a decomposition chamber (307).

The inlet arrangement (303) comprises in the downstream direction
a) The inlet port (305a+b). This figure illustrates a variant in which there may one inlet port (305a N₂O) for nitrous oxide (301a) and one (305b O₂) for oxygen/air (301b). There are also corresponding branch conduits (302a and 302b, respectively) merging (335) the two branch conduits (302a and 302b) to the common main flow line (302).
b) A flow creating function (323), preferably a blower. This function is advantageously placed in a gas proof box (336) in order to prevent leakage of nitrous oxide to ambient atmosphere. An alternative position for this function is within the outlet arrangement (303) and then preferably downstream of the cooling function of a heat exchanger (315a) and upstream of a cooling function (317b) based on inlet of cooling gas (320).
c) A flow meter (325) downstream of a flow creating function (323) (if this function is present in the inlet arrangement (303)).
d) A heating arrangement (315a+b) comprising
   a) heat exchanger (315a) in which hot gas which is leaving the decomposition chamber (307) is used to heat incoming gas to be processed in the decomposition chamber (307), and
   b) a heater (315b) which advantageously is associated with a temperature sensor (329), preferably designed as a safety thermostat. This heater is preferably placed in a gap (334a, distributor function) next to the upstream end of the decomposition chamber (307). The gap is devoid of catalyst material and preferably also of heat neutralizing medium, such as heat adsorbing material. An alternative position for this heater is within the inlet conduit (302), with preference for downstream of the flow sensor (325) (if present) and the flow creating function (323).

The design with two inlet ports with inlet conduits and a branching may be placed on the apparatus as illustrated or upstream of the apparatus (not shown), e.g. as an integrated part of a face mask. The design is adapted for patients alternately using two face masks, such as at maternity care during delivery when the mother alternate between inhaling a nitrous oxide mixture and oxygen or air. For patients using only one face mask it will suffice with one inlet port on the apparatus. A design with one inlet port also suffices if the gas to be processed does not contain exhalation air but still derives from health care use of nitrous oxide. An attractive such use not requiring two inlet ports is to decompose nitrous oxide which derives from nitrous oxide that has been desorbed from a nitrous oxide adsorbent that previously has been loaded with nitrous oxide present in exhalation air.

The merging (335) may be associated with a valve function enabling separate opening of each of the two branches/ports or simultaneous opening of them depending on the number of different flows (one or two) entering the unit and how they are going to be treated in the unit. This valve function, if present, is preferably simple, e.g. separate closing/opening of a desired one of the two inlet ports (305a and 305b) by a plug or a cover, or a true valve encompassing closing/opening at the merging point or within the branch conduits.

The heater (315b) is placed downstream of the heating function of heat exchanger (315a) (if present).

The decomposition chamber (307) comprises
e) The catalyst material (308) and the heat neutralizing medium (309) which preferably are of the same kinds as used in the experimental part or as described elsewhere in this specification. In addition there may also be temperature sensors (327a,b,c) preferably arranged as discussed in the experimental part above or elsewhere in this specification.

The outlet arrangement (304) comprises
f) A gap (334b) (collector function) downstream of the decomposition chamber (307). The gap is devoid of catalyst material and preferably also of heat neutralizing medium, such as heat adsorbing media.
g) The heat exchanger discussed as item (d) above (315a) will at this position work as a first downstream cooling arrangement (317a) by transferring heat in gas which exits the decomposition chamber to incoming gas which is about to enter the decomposition chamber (alternative (iii) of downstream cooling arrangements).
h) A second downstream cooling arrangement (317b) which is of the same kind as downstream cooling arrangement (117,217b) in FIGS. 1 and 2. This arrangement (317b) comprises inlet conduit (319) for a cooling gas (320, preferably air) along which there is a blower (321) (alternative (i) of downstream cooling arrangements).
i) Preferably a temperature sensor (328) which is placed between the inlet conduit (319) and the outlet port (306).

The various functions described above may be placed in a common housing (337). Parts/functions which will become warmed up during use of the apparatus should be properly heat insulated by the appropriate heat insulating material. See discussion about heat insulating material (118) in FIG. 1.

Preferred variants developed during the priority year thus have no inlet flow line (111,211) for a diluting gas (112,212), no valve function (124,224) for regulating the influx flow velocity of the diluting gas (112,212), and no by-pass function (130,230). In other words the gas diluting function (110,210) and by-pass function (130,230) are not needed. The sensor arrangement (125,225) in the form of a pressure sensor is preferably replaced with a flow meter which is placed downstream of a flow creating function (323) if such function is present in the inlet arrangement.

In addition to the heating element (315b) (115,215 in FIGS. 1 and 2), the heating arrangement of the preferred variant in FIG. 3 comprises a heat exchanger (315a) in which warm gas leaving the decomposition chamber (depleted in nitrous oxide) is used to heat incoming gas rich in nitrous oxide.

A flow creating function (323) such as a blower positioned upstream of the decomposition chamber (307) is preferably placed in a gas-proof box (336) in order to prevent leakage of nitrous oxide into ambient atmosphere.

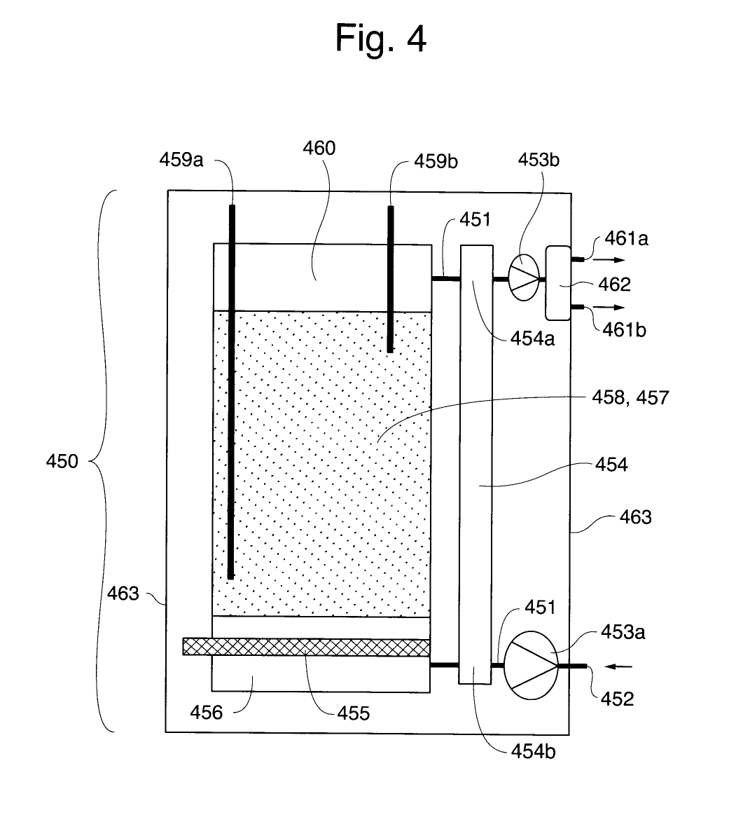

FIG. 4 describes an adsorption unit (450) in which there is a porous adsorbent (458) for adsorbing nitrous oxide from an individual exhaling air containing nitrous oxide via a face mask and subsequently desorbing the adsorbed nitrous oxide. The flow direction during desorption is indicated with arrows. The flow during adsorption has the opposite direction meaning that the inlet port (452) becomes an outlet port and an outlet port (461a+b) becomes an inlet port. For the adsorption unit given in this figure this means that upstream and downstream positions become downstream and upstream positions, respectively, when the flow directions are changed, i.e. going from adsorption to desorption or vice versa. The unit comprises a main flow line (451) comprising in the direction of the flow used for desorption:
i) An inlet port (452) for a desorbing gas, preferably ambient air.
ii) A flow creating function (453a), preferably a blower, which is only used during adsorption and preferably is battery driven,
iii) A heating arrangement (454+455) for heating desorbing gas to support desorption. This arrangement is only used during desorption of nitrous oxide which has been loaded onto the unit/adsorbent prior to desorption. The heating arrangement comprises
   a) a heat exchanger (454) in which heat in gas leaving the adsorbent (458) through its downstream end is transferred to desorbing gas which is about to enter the adsorbent (458) through its upstream end, and
   b) a heater (455) placed in a gap (456, distribution function) next to the upstream end of the adsorbent (458),
iv) An adsorption chamber (457) which contains the adsorbent (458) for adsorption of nitrous oxide. The unit contains one or more sensors (459a,b) for indicating in real time the degree of saturation of the adsorbent bed with respect to nitrous oxide. In the variant of this figure one temperature sensor (459a) is placed in a zone close to the upstream end of the bed and at least one more temperature sensor (459b), one of which is close to the downstream end of the adsorbent. The temperature sensors are used a) during adsorption of nitrous oxide to indicate in real time how an adsorption front (heated zone) is approaching the outlet end (460) of the adsorbent (adsorption flow, adsorption is exothermic), and b) during desorption to control the desorption, e.g. the heater (455), proper desorption temperature, when to turn off the heater, when to turn off the flow creating functions (453b,323) etc. See and our copending international patent application “System” filed in parallel with this application (cited above).
v) A gap (460, collector function) next to the upstream end of the adsorbent bed (458) followed by the cooling function (454a) of the heat exchanger (454).
vi) Preferably a flow creating function (453b), such as blower, placed downstream of the cooling function (454a) of the heat exchanger (454).
vii) An outlet port (461a+b) for exit of desorbing gas. This port is used as inlet port during adsorption, i.e. be connected to a patient inhaling/exhaling nitrous oxide. This port may therefore have one or two ports (461a,b) with branch conduits merging (462) to the main flow line (452) for the same reasons as inlet port (305) of the apparatus according to FIG. 3. It will also be convenient with two outlet ports (461a,b) if the desorbed nitrous oxide is to be further processed in an apparatus (300, FIG. 3) having to inlet ports (305a,b).

The various functions of the adsorption unit (450) described above may be placed in a common housing (463).

### Desorption/Decomposition

During desorption the inlet port (461a+b) of an adsorption unit according to FIG. 4 is connected to the inlet port (305a+b) of an apparatus for further processing (300 in FIG. 3). After the apparatus (300) and the adsorption unit (450) have been started and adapted to predetermined desorption/decomposition conditions, desorbing gas in the form of ambient air is
a) sucked into the adsorption unit (450) via the inlet port (461a+b),
b) heated by the heating arrangement (454+455) prior to passing through the adsorbent (458),
c) exiting the adsorbent (458) together with desorbed nitrous oxide,
d) cooled in the heat exchanger (454), and
e) finally exiting the unit (450) through its outlet port (452) while entering the apparatus for further processing (300 of FIG. 1) where nitrous oxide is catalytically decomposed to N₂ and O₂.

During desorption the heater (455) and the flow creating function (453b) on the adsorption unit (451) and the flow creating functions (323) and (321) and the heating arrangement (315) on the apparatus (300) are turned on. The flow creating functions (453b) and (323), i.e. the desorption flow, is controlled by the flow sensor (325) on the decomposition apparatus to be within presets limits (cable between the adsorption unit and the decomposition apparatus). The sucking force will be the pressure differential caused by the flow creating function (323) and supported by the flow creating function (453b). The flow creating function (453a) on the adsorption unit (450) is turned off during desorption of nitrous oxide. During desorption, the adsorbent will be warmed up by the heater (455) starting from the end next to the heater (455) (sensor (459a) 100-200° C.). When the temperature at the sensor (459b) at the opposite end of the adsorbent has reached a predetermined value (about 100° C.) the heater (455) is turned off. Either one or both of the flow creating functions (453b) and (323) is on for 1-2 additional hours in order to complete desorption (about 40° C. at temperature sensor (459a) at the outlet end (460) of the adsorbent). The heater (454) is controlled from the apparatus (300) (cable).

An apparatus of the invention, such as variants illustrated in FIG. 3, as well as the adsorption unit of FIG. 4 may be equipped with wheels to support mobility. Proper face masks for inhalation of gas containing nitrous oxide and/or oxygen/air, respectively, as well as gas tubes containing these gases may be connected the adsorption unit. This also applies to the apparatus in case it is intended to be connected directly to a patient via a face mask.

### EXPERIMENTAL PART

### Apparatus

The apparatus is according to FIG. 1. The decomposition chamber (107) contains a heat absorber (109) in the form of particles mixed with catalyst material (108) (both of the same kinds as given in the experimental part of WO 2010071538 (Nordic Gas Cleaning AB)). Heater (115): 1.5 kW. Blowers F1 (123) and F2 (123) are frequency controlled via the control block (126). There are three temperature sensors T1-T3 (127a-c) in the decomposition chamber and one T4 (128) at the main outlet (106).

### Gas to be Processed

Inlet flow from tube (via inlet port (105)): 50% nitrous oxide, 50% oxygen 500 000 ppm itrous oxide 4-15. Diluting air (via conduit (111): 10-150 mL/min. Cooling air (via conduit 119): 10-100 m³/h

### Procedure

1. Turn on blower (123) for flow through the decomposition chamber (107), open valve (124) in diluting function (110) and valve (132b) in by-pass function (130), and close by-pass valve (132a).

2. Turn on heating arrangement (115) which is controlled by temperature sensor T1 (127a)

3. Blower F1 (123) (flow through decomposition chamber): Set a fixed subpressure interval 100 Pa-1500 Pa and a flow interval for F1>0.5 m³/h.

4. Blower F2 (121) (cooling air): Set a flow interval for F2>25 m³/h.

5. Controlling temperature sensor (127a): Set a temperature T1 (127a) in the interval 600-700° C.

6. For this example the selected starting process parameters are: T1 (127a) is 620° C., F1 is 2 m³/h and F2 is 50 m³/h

7. Open inlet flow of gas to be processed (nitrous oxide+oxygen) 0.7 m³/h

### Observations

The temperature T1 (127a) rises to 660° C. and the heater (115) is switched off (temperature increase due to heat developed by decomposition of N₂O)

The temperature at sensor T2 (127b) stabilizes around 690° C.

The temperature at T4 (128) is 4° C.

### Results

The concentration of nitrous oxide entering the decomposition chamber: 125.000 ppm. (4 times dilution by influx through air valve (124).

Nitrous oxide in gas discharged from main outlet (106): <10 ppm (measured by IR).

Process time: about 30 minutes.

While the invention has been described and pointed out with reference to operative embodiments thereof, it will be understood by those skilled in the art that various changes, modifications, substitutions and omissions can be made without departing from the spirit of the invention. It is intended therefore that the invention embraces those equivalents within the scope of the claims which follow.

1-10. (canceled)

11. An apparatus for the removal of nitrous oxide in a gas stream containing nitrous oxide which is derived from exhalation air and present in the gas stream in a concentration supporting exothermic decomposition of nitrous oxide, said apparatus comprising a main flow line having:
a) an inlet arrangement with an inlet port,
b) an outlet arrangement with an outlet port, and between these arrangements
c) a through-flow removal chamber which is a decomposition chamber, wherein the apparatus comprises:
I) a catalyst material promoting the decomposition of nitrous oxide to N₂ and O₂ together with a heat neutralizing medium in the decomposition chamber, and possibly also
II) a gas diluting function comprising an inlet flow line for a diluting gas merging with the main flow line at a position upstream of the decomposition chamber.

12. The apparatus of claim 11, wherein the catalyst material comprises particles and/or the heat neutralizing medium is a heat absorber.

13. The apparatus of claim 11, wherein the catalyst material and the heat absorbing material are particles which are mixed with each other in the decomposition chamber to form a porous bed.

14. The apparatus of claim 11, wherein the main flow line comprises a heating arrangement, preferably adjustable with respect to effect, which is placed upstream of or in the upstream part of the decomposition chamber.

15. The apparatus of claim 11, further comprising one, two or more downstream cooling arrangements which are acting on the gas stream in the main flow line downstream of the decomposition chamber and in at least one of these downstream cooling arrangements being adjustable with respect to cooling effect.

16. The apparatus of claim 15, wherein at least one of said one, two or more downstream cooling arrangements comprises:
i) an inlet flow line for inlet of a cooling gas into the main gas flow line to be mixed with the gas stream in the main flow line at a position downstream of the decomposition chamber,
said inlet flow line comprising a flow creating function, such as an adjustable blower, or
ii) a heat absorber in the form of a fixed heat absorbent in heat transfer contact with gas passing through the main flow line, or
iii) a heat absorber, which comprises conduits containing a stream of cooling fluid in heat transfer contact with gas passing through the main flow line.

17. The apparatus of claim 16, wherein one of said one, two or more downstream cooling arrangements is according to alternative (i) and placed downstream of any of the other downstream cooling arrangements (if present).

18. The apparatus of claim 16, wherein one of said one, two or more downstream cooling arrangements is according to alternative (iii) and is a heat exchanger.

19. The apparatus of claim 16, wherein the inlet arrangement of the main flow line comprises an inlet flow line for a diluting gas and/or the main flow line comprises a flow creating function such as a blower.

20. The apparatus of claim 16, wherein the apparatus comprises one or more temperature sensors for measuring temperature within the decomposition chamber and/or one or more temperature sensors for measuring the temperature in the gas stream downstream of or within one or more of the downstream cooling arrangements.
